(19) United States
(12) Patent Application Publication
(10) Pub. No.: US 2010/0098262 A1
(43) Pub. Date: Apr. 22, 2010

(54) METHOD AND HEARING DEVICE FOR PARAMETER ADAPTATION BY DETERMINING A SPEECH INTELLIGIBILITY THRESHOLD

(76) Inventor: Matthias Fröhlich, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/579,512

(22) Filed: Oct. 15, 2009

(30) Foreign Application Priority Data
Oct. 17, 2008 (DE) 10 2008 052 176.0

(51) Int. Cl. H04R 29/00

(52) U.S. Cl. 381/60

(57) ABSTRACT

A method and a hearing device are proposed to adapt at least one hearing device parameter. A first speech intelligibility threshold is determined. The determined first speech intelligibility threshold is compared with a predefinable reference value and is adapted the at least one hearing device parameter on the basis of the comparison. This is advantageous in that hearing device parameters, which could previously not be individually set as a result of objective measuring data, can be adjusted by an objective measurement.

### CROSS REFERENCE TO RELATED APPLICATIONS

This application claims priority of German application No. 10 2008 052 176.0 filed Oct. 17, 2008, which is incorporated by reference herein in its entirety.

### FIELD OF THE INVENTION

The invention relates to a method and a hearing device for adapting hearing device parameters.

### BACKGROUND OF THE INVENTION

Hearing devices are wearable hearing apparatuses which are used to assist the hard-of-hearing. In order to accommodate numerous individual requirements, various types of hearing devices are available such as behind-the-ear hearing devices, hearing devices with an external receiver and in-the-ear hearing devices, for example also concha hearing devices or completely-in-the-canal hearing devices. The hearing devices listed as examples are worn on the outer ear or in the auditory canal. Bone conduction hearing aids, implantable or vibrotactile hearing aids are also available on the market. The damaged hearing is thus stimulated either mechanically or electrically.

The key components of hearing devices are principally an input converter, an amplifier and an output converter. The input converter is normally a receiving transducer e.g. a microphone and/or an electromagnetic receiver, e.g. an induction coil. The output converter is most frequently realized as an electroacoustic converter e.g. a miniature loudspeaker, or as an electromechanical converter e.g. a bone conduction hearing aid. The amplifier is usually integrated into a signal processing unit. This basic configuration is illustrated in FIG. 1 using the example of a behind-the-ear hearing device. One or a plurality of microphones 2 for recording ambient sound are built into a hearing device housing 1 to be worn behind the ear. A signal processing unit 3 which is also integrated into the hearing device housing 1 processes and amplifies the microphone signals. The output signal for the signal processing unit 3 is transmitted to a loudspeaker or receiver 4, which outputs an acoustic signal. Sound is transmitted through a sound tube, which is affixed in the auditory canal by means of an otoplastic, to the device wearer's eardrum. Power for the hearing device and in particular for the signal processing unit 3 is supplied by means of a battery 5 which is also integrated in the hearing device housing 1.

Before use by the hearing device wearer, the hearing device is set by means of a hearing device acoustician in accordance with the hearing loss of the wearer. The settings are generally based on a measured audiogram, supplemented by a query relating to possible experiences with hearing devices, personal preferences or characteristics and/or specifications in respect of the special acoustic coupling. The amplifications and compressions derived therefrom are individually preset in the individual frequency bands and are if necessary finely adjusted by the hearing device acoustician. Further parameters, such as compression time constants, noise suppression, directional effect etc. can either be set automatically on the basis of questions or the age of the wearer or can be set manually by the acoustician during a consultation, or are permanently preconfigured in the hearing device. These parameters are therefore not necessarily optimally adjusted in a manner specific to the wearer.

### SUMMARY OF THE INVENTION

It is the object of the invention to optimize preset hearing device parameters in a manner specific to the hearing device wearer and to specify a method and an apparatus which enable an adaptation of hearing device parameters.

In accordance with the invention, the set object is achieved by the claims.

The invention claims a method for adapting at least one hearing device parameter with a determination of a first speech intelligibility threshold, with a comparison of the determined first speech intelligibility threshold with a predefinable reference value and with an adaptation of the at least one hearing device parameter on the basis of the comparison. This is advantageous in that hearing device parameters, which were previously not individually adjusted on the basis of objective measurement data, can be adjusted by means of an objective measurement.

In one development, a first speech intelligibility threshold can be determined by a hearing device, with data being exchanged between the hearing device and an external unit, the determined first speech intelligibility threshold can be compared with a predefinable reference value stored in the hearing device and at least one hearing device parameter can be adapted on the basis of the comparison in the hearing device. As a result, the adaptation can be performed in an exclusively hearing device-controlled fashion.

In a further embodiment, the external unit can be interactively controlled by means of a hearing device user. The external unit may also be part of the hearing device. An adaptation of the hearing device parameters can only be performed by the hearing device wearer him/herself without a hearing device acoustician by controlling an external unit.

The first speech intelligibility threshold can preferably be determined with a modulated noise. This is advantageous in terms of a practical simulation.

The reference value can also take place on a statistical basis and can be permanently stored in the hearing device or the external unit.

Furthermore, the reference value can be determined as a second speech intelligibility threshold. The result can thereby be individualized more and therefore improved.

The inventive method can also include an interactive control of the external unit by means of a hearing device user when determining the reference value. A simple and reliable operator guidance is advantageous here.

In a further development of the invention, the second speech intelligibility threshold can be determined with a stationary noise. Good, individualized adaptation results can be achieved as a result.

In one development, the comparison can include a differentiation from the first speech intelligibility threshold and the reference value. This is advantageous in terms of a simple and robust comparison.

The hearing device parameters can preferably include time constants of the compression and/or time constants of the fading in/out of a noise reduction and/or omnidirectional/directional cross fading. These parameters were as a rule previously still not individualized objectively.

In a further embodiment, current speech intelligibility tests for speech in noise, such as for instance in the German language room of the Oldenburg speech intelligibility test (O1Sa), Göttingen sentence test (GöSa), or individual tones or narrow band noise signals, can be used to determine the first and/or second speech intelligibility threshold. This has the advantage of a realization based on scientific foundations.

Furthermore, a basic setting of the hearing device parameters can also be performed on the basis of an audiogram prior to determining the first and/or second speech intelligibility threshold. An optimal starting basis is created as a result for an inventive adaptation.

The invention also claims a hearing device with a control unit for implementing an inventive method. The hearing device includes a comparison unit, which compares the determined first speech intelligibility threshold with a predefinable reference value.

The invention also claims an external unit for implementing an inventive method. This has the advantage of a simple and automated operation.

The invention also claims a computer program product with a computer program, which has the software means for implementing an inventive method, if the computer program is executed in a control unit.

### BRIEF DESCRIPTION OF THE DRAWINGS

Further details and advantages of the invention are apparent from the descriptions which follow of several exemplary embodiments with reference to schematic drawings, in which;

FIG. 1: shows a basic design of a hearing device according to the prior art,

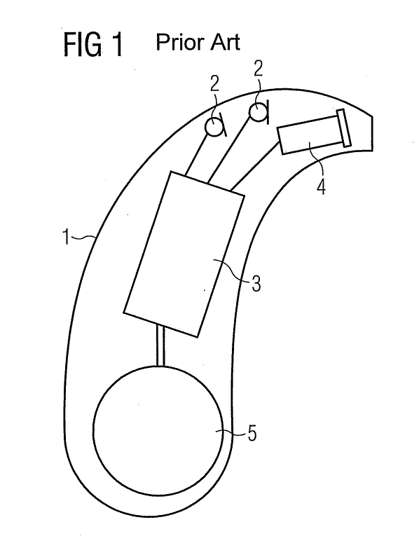

FIG. 2: shows a flow chart when determining a first speech intelligibility threshold,

FIG. 3: shows a flow chart when determining a first and a second speech intelligibility threshold and

FIG. 4: shows a block diagram of a hearing device and an external unit.

### DETAILED DESCRIPTION OF THE INVENTION

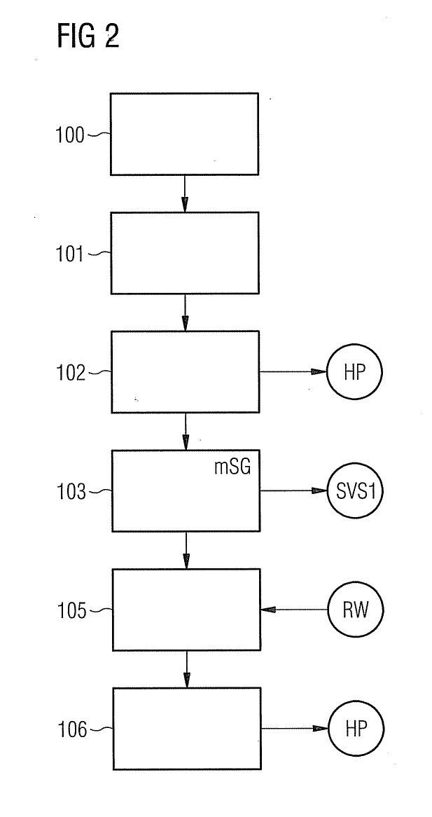

FIG. 2 shows a flow chart of an inventive method for adapting hearing device parameters HP. In step 100, a hearing device wearer is provided with a hearing device and an external unit. An audiogram is then newly determined or provided in step 101 by means of a hearing device acoustician for instance. In step 102, the hearing device parameters HP, such as amplification and compression, are adjusted in the hearing device on the basis of the audiogram. Further parameters HP, such as compression time constants, noise suppression and directional effect, are set in a device-specific fashion or based on questions integrated into the adjustment software and do not refer to the measurable hearing ability of the user. In order to be better able to individualize these parameters HP, a first speech intelligibility threshold SVS1 is determined in step 103.

Hardness of hearing is perceived by most people particularly as a result of their problems when communicating in noisy environments. To obtain a realistic measure for this hearing impairment, speech intelligibility tests in noise are implemented in the hearing diagnostics. The everyday situation can be recreated as accurately as possible by speech intelligibility tests being used in noise, in which individual words or whole sentences are shown as a useful signal. A test of this type determines the speech intelligibility threshold. The speech intelligibility threshold corresponds to 50% of the speech intelligibility, with the number of correctly understood words being counted.

The Oldenburg sentence test is known and can be successfully used for the determination of the speech intelligibility threshold for instance. The speech material is made up of 40 test lists of 20 or 30 sentences respectively. The sentences each take the form: Name Verb Numeral Adjective Object with a random combination made of an inventory of a total of 50 words. As a result, the sentences are not always useful so that the lists cannot be learned off by heart and can therefore be measured repeatedly therewith.

The first speech intelligibility threshold SVS1 is determined with an afore-cited sentence test, with both the spoken sentences as well as a modulated noise mSG being passed on by the hearing device. The noise mSG corresponds to a noise simulating speech, which, in the long term spectrum, corresponds to that of the sentence material. The first speech intelligibility threshold SVS1 is determined by means of an adaptive controller. Here the modulated noise mSG is usually displayed in the measurement at a fixed level. The level of the speech is changed adaptively, in other words in accordance with the response of the hearing device wearer. The measurement is controlled with the aid of an external unit, for instance a remote controller, by the hearing device wearer. The correctly understood words can be detected by means of an interactive control of the external unit.

In the following step 105, the first speech intelligibility threshold SVS1 determined in step 103 is compared with a reference value RW stored in the hearing device. To this end, the difference between the first speech intelligibility threshold SVS1 and the reference value RW is formed for instance. If the difference exceeds a certain value, the hearing device wearer can “hear in the gaps” and the time constants of the compression and possibly other parameters could be adjusted.

The adjustment of the hearing device parameter HP according to the evaluation in step 105 takes place in step 106.

With the adapted hearing device parameters HP, the inventive method according to FIG. 2 can be repeated in order to monitor the settings. The method can proceed in a controlled fashion automatically by the hearing device and the external unit without involving a hearing device acoustician.

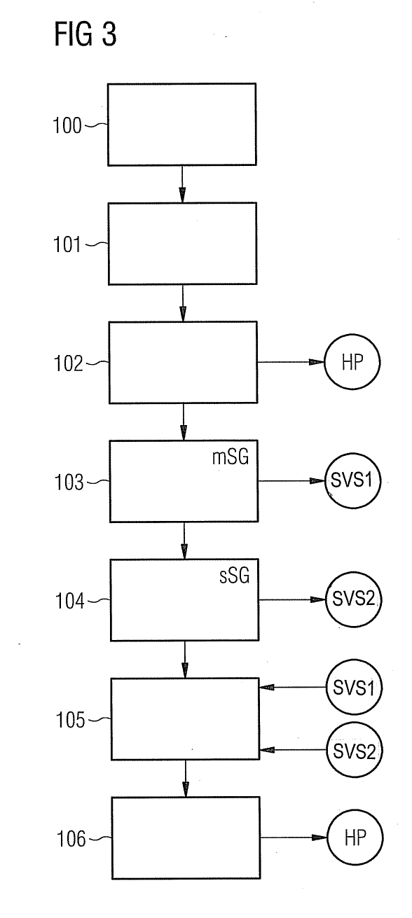

FIG. 3 shows a flow chart of a further inventive method for the adaptation of hearing device parameters HP. In step 100, a hearing device and an external unit are provided to a hearing device wearer. An audiogram is then determined in step 101 by means of a hearing device acoustician. The hearing device parameters HP, such as amplification and compression, are set in the hearing device in step 102 on the basis of the audiogram. Further parameters HP, such as the compression time constants, the noise suppression and directional effect, are adjusted in a device-specific fashion and do not refer to the hearing ability of the user. In order to be better able to individualize these parameters HP, a first speech intelligibility threshold SVS1 is determined in step 103. The first speech intelligibility threshold SVS1 is determined with a sentence test described above in FIG. 2, with both the spoken sentences and also a modulated noise mSG being passed on to the hearing device. The noise mSG corresponds to a speech-simulating noise, which in the long term spectrum corresponds to that of the sentence material. The first speech intelligibility threshold SVS1 is determined by means of an adaptive controller. Here the modulated noise mSG is shown in the measurement at a fixed level. The level of the speech is adaptive, in other words is changed according to the response of the hearing device wearer. The measurement is controlled by the hearing device wearer with the aid of an external unit, for instance a remote controller. The correctly understood words can be detected by means of an interactive control of the external unit.

Contrary to FIG. 2, a second speech intelligibility threshold SVS2 is determined as a reference value RW in step 104 in the method according to FIG. 3. The second speech intelligibility threshold SVS2 only differs from the first SVS1 in that a stationary noise sSG is used instead of the modulated noise mSG. This is also provided by the hearing device and passes directly to the hearing device wearer by way of the receiver.

In the following step 105, the first speech intelligibility threshold SVS1 determined in step 103 is compared with the second speech intelligibility threshold SVS2 determined in step 104. To this end, the difference between the first speech intelligibility threshold SVS1 and the second speech intelligibility threshold SVS2 is formed for instance. If the difference exceeds a certain value, the hearing device wearer can “hear in the gaps” and the time constants of the compression and possibly other parameters could be adjusted.

The hearing device parameters HP are adjusted in step 106.

With the adapted hearing device parameters HP, the inventive method according to FIG. 3 can be repeated in order to monitor the settings. The method proceeds in a controlled fashion automatically by interaction with an external unit without involving a hearing device acoustician.

As an alternative to the use of a sentence test with spoken words in the case of the method according to FIGS. 2 and 3, individual tones or narrow band noise signals can be used to estimate first and second speech intelligibility thresholds SVS1, SVS2.

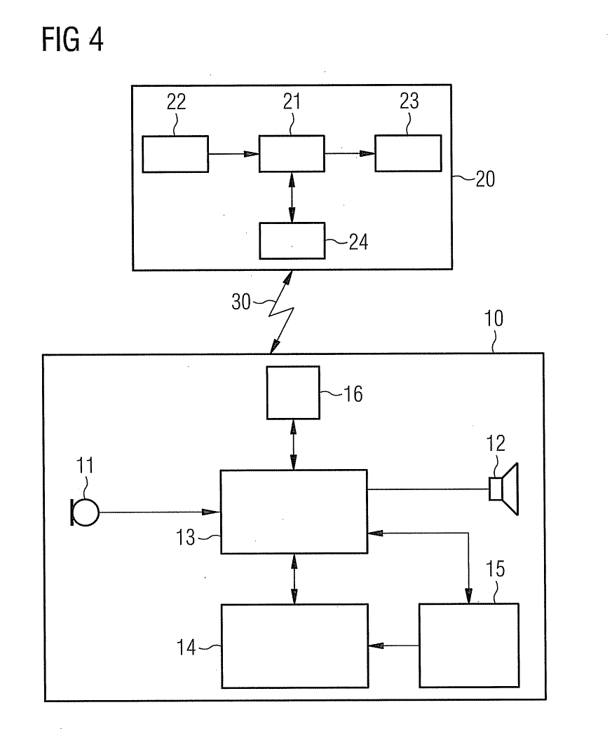

FIG. 4 shows a significantly simplified block diagram of an inventive arrangement comprising a hearing device 10 and an external unit 20, which can exchange data with one another by means of a radio transmission 30. Acoustic signals can be received by a microphone 11 and fed to a signal processing and control unit 13. The signals are inter alia amplified and adapted there and fed to a receiver 12 for output to a user.

The determination of the first and second speech intelligibility threshold SVS1, SVS2 is controlled by the control unit 13. To this end, the control unit 13 can access words and/or sentences stored in a storage unit 15 or individual sequences or narrow band noise signals. The control unit 13 is also connected to a comparison unit 14, which, for instance by means of differentiation, compares the determined first speech intelligibility threshold SVS1 with the deter mined second speech intelligibility threshold SVS2. Preset hearing device parameters HP are changed from the result of the comparison.

The hearing device 1 can communicate wirelessly with an external unit 20, for instance with a remote controller, with the aid of a radio module 16, which is connected to the control unit 13. To send and receive data, the external unit 20 likewise has a radio module 24, which is connected to a control module 21. The adaptation of the hearing device parameter HP can be operated and controlled by a user by measuring the speech intelligibility thresholds SVS1, SVS2 by way of an input unit 22 and a display unit 23.

### List of Reference Characters

1 Hearing device housing
2 Microphone
3 Signal processing unit
3 Receiver
5 Battery
10 Hearing device
11 Microphone
12 Receiver
13 Control and signal processing unit
14 Comparison unit
15 Storage unit
16 Radio module
20 Remote control/external unit
21 Control module
22 Input unit
23 Display unit
24 Radio module
30 Radio transmission path
100 Hearing device preparation
101 Audiogram determination
102 Hearing device parameter basic setting
103 Determination of the first speech intelligibility threshold
104 Determination of the second speech intelligibility threshold
105 Comparison of the first speech intelligibility threshold <> reference value
106 Adaptation of the hearing device parameters
HP Hearing device parameter
mSG Modulated noise
RW Reference value
sSG Stationary noise
SVS1 First speech intelligibility threshold
SVS2 Second speech intelligibility threshold

1.-14. (canceled)

15. A method for adapting a hearing device parameter of a hearing device, comprising:
determining a first speech intelligibility threshold by the hearing device;
comparing the first speech intelligibility threshold with a reference value; and
adapting the hearing device parameter based on the comparison by the hearing device.

16. The method as claimed in claim 15, wherein the first speech intelligibility threshold is determined with a modulated noise.

17. The method as claimed in claim 15, wherein a differentiation between the first speech intelligibility threshold and the reference value is compared.

18. The method as claimed in claim 15, wherein the hearing device parameter is selected from the group consisting of: a time constant of the compression, a time constant of a fading in and fading out of a noise reduction, a omni cross fading, and a directional cross fading.

19. The method as claimed in claim 15, wherein data is exchanged between the hearing device and an external unit.

20. The method as claimed in claim 19, wherein the reference value is stored in the hearing device or in the external unit.

21. The method as claimed in claim 19, wherein the external unit is interactively controlled by a user of the hearing device.

22. The method as claimed in claim 19, wherein the reference value is determined as a second speech intelligibility threshold.

23. The method as claimed in claim 22, wherein the external unit is interactively controlled by a user of the hearing device when determining the reference value.

24. The method as claimed in claim 22, wherein the second speech intelligibility threshold is determined with a stationary noise.

25. The method as claimed in claim 22, wherein the first speech intelligibility threshold or the second speech intelligibility threshold is determined by a sentence test, or by an individual tone, or by a narrow band noise signal.

26. The method as claimed in claim 22, wherein a basic setting of the hearing device parameter is performed by an audiogram prior to determining the first speech intelligibility threshold or the second speech intelligibility threshold.

27. The method as claimed in claim 26, wherein the sentence test comprises Oldenburg speech intelligibility test.

28. A hearing device, comprising:
a control unit that determines a first speech intelligibility threshold; and
a comparison unit that compares the first speech intelligibility threshold with a reference value for adapting a hearing device parameter by the hearing device.

29. A computer program product executable in a control unit of a hearing device, comprising:
a computer program that:
determines a first speech intelligibility threshold by the hearing device;
compares the first speech intelligibility threshold with a reference value; and
adapts the hearing device parameter based on the comparison by the hearing device.
